(19) United States
(12) Patent Application Publication
(10) Pub. No.: US 2019/0310678 A1
(43) Pub. Date: Oct. 10, 2019

(54) Pedal Assembly For A Vehicle

(71) Applicant: GM GLOBAL TECHNOLOGY OPERATIONS LLC, Detroit, MI (US)

(72) Inventors: James Wojciechowski, Warren, MI (US); Tomasz R. Warzecha, Sterling Heights, MI (US); James A. Webster, Shelby Township, MI (US)

(21) Appl. No.: 15/946,111

(22) Filed: Apr. 5, 2018

(51) Int. Cl. G05G 1/36; G05G 5/03; B60K 26/02; B60T 7/06

(52) U.S. Cl. CPC G05G 1/36; G05G 5/03; G05G 1/38; B60T 7/06; B60K 26/021

(57) ABSTRACT

An automotive vehicle includes a body having a passenger compartment and a movable pedal housing which is movable between first and second positions with respect to the passenger compartment. The vehicle additionally includes at least one pedal which is operably coupled to the housing and actuatable by an occupant. The vehicle also includes an actuator operably coupled to the pedal and to the housing. The actuator is configured to apply a resistive force to the pedal to resist motion of the pedal. The actuator is configured to selectively move the housing between the first and second positions. The vehicle further includes at least one controller configured to, in response to satisfaction of a first operating condition, control the actuator to move the pedal housing to the first position, and, in response to satisfaction of a second operating condition, control the actuator to move the pedal housing to the second position.

### TECHNICAL FIELD

The present disclosure relates to vehicles controlled by automated driving systems, particularly those configured to automatically control vehicle steering, acceleration, and braking during a drive cycle without human intervention.

### INTRODUCTION

The operation of modern vehicles is becoming more automated, i.e. able to provide driving control with less and less driver intervention. Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

### SUMMARY

An automotive vehicle according to the present disclosure includes a body having a passenger compartment and a movable pedal housing disposed within the passenger compartment. The movable pedal housing is movable between a first position with respect to the passenger compartment and a second position with respect to the passenger compartment. The vehicle additionally includes at least one pedal which is operably coupled to the housing and actuatable by an occupant. The vehicle also includes an actuator operably coupled to the pedal and to the housing. The actuator is configured to apply a resistive force to the pedal to resist motion of the pedal. The resistive force has a controllable magnitude. The actuator is configured to selectively move the housing between the first position and the second position. The vehicle further includes at least one controller in communication with the actuator. The controller is configured to, in response to satisfaction of a first operating condition, control the actuator to move the pedal housing to the first position, and, in response to satisfaction of a second operating condition, control the actuator to move the pedal housing to the second position.

In an exemplary embodiment, the vehicle additionally includes a shaft coupled to the pedal and a gearing element operably coupled to the actuator, wherein the shaft is provided with a plurality of gear teeth in meshing engagement with the gearing element such that translation of the shaft drives the gearing element in rotation.

In an exemplary embodiment, the vehicle additionally includes a rail coupled to an interior portion of the passenger compartment, with the pedal housing being slidably coupled to the rail. Such embodiments may further include a locking member disposed at the interior portion of the passenger compartment, with the locking member being selectively engageable with the pedal housing to secure the pedal housing in a fixed position relative to the rail.

In an exemplary embodiment, the first operating condition comprises an automated driving system controlling vehicle driving behavior, and wherein the second operating condition comprises the automated driving system not controlling vehicle driving behavior.

A pedal assembly for a vehicle according to the present disclosure includes a track, a pedal housing slidably coupled to the track, and at least one pedal operably coupled to the housing and actuatable by an occupant. The assembly additionally includes an actuator operably coupled to the pedal housing and configured to selectively move the housing between a stowed position with respect to the track and a deployed position with respect to the track. The actuator is configured to actuate the pedal housing to the deployed position in response to a deploy command from a controller and to actuate the pedal housing to the stowed position in response to a stow command from the controller.

In an exemplary embodiment, the actuator is operably coupled to the pedal and configured to apply a resistive force to the pedal to resist motion of the pedal. The resistive force has a controllable magnitude. Such embodiments may additionally include a shaft coupled to the pedal and a gearing element operably coupled to the actuator. In such embodiments, the shaft is provided with a plurality of gear teeth in meshing engagement with the gearing element such that translation of the shaft drives the gearing element in rotation.

In an exemplary embodiment, the controller is configured to generate the deploy command in response to satisfaction of a first operating condition and to generate the stow command in response to satisfaction of a second operating condition. In such embodiments, the second operating condition may include an automated driving system controlling vehicle driving behavior, and the first operating condition may include the automated driving system not controlling vehicle driving behavior.

A method of controlling an automotive vehicle according to the present disclosure includes providing a vehicle with a first actuator configured to control vehicle acceleration or braking, a controller configured to selectively control the actuator in an autonomous mode according to an automated driving system, a pedal assembly having a housing and at least one pedal operably coupled to the pedal housing, and a second actuator coupled to the pedal housing and operably coupled to the pedal housing and to the pedal. The method additionally includes, in response to the controller controlling the first actuator in the autonomous mode, automatically controlling the second actuator, via the controller, to actuate the pedal housing to a stowed position. The method further includes, in response to the controller not controlling the first actuator in the autonomous mode, automatically controlling the second actuator, via the controller, to actuate the pedal housing to a deployed position and to apply a resistive force to the pedal to resist motion of the pedal.

Embodiments according to the present disclosure provide a number of advantages. For example, the present disclosure provides a system and method for providing control interfaces to a vehicle operator when useful, and moving such control interfaces out of the operator's way when unnecessarily, thereby avoiding unintentional control inputs and increasing occupant comfort.

The above and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic diagram of a communication system including an autonomously controlled vehicle according to an embodiment of the present disclosure;

FIG. 2 is a schematic block diagram of an automated driving system (ADS) for a vehicle according to an embodiment of the present disclosure;

FIG. 3 is a schematic view of a pedal assembly according to a first embodiment of the present disclosure;

FIGS. 4A and 4B are schematic views of a vehicle according to an embodiment of the present disclosure;

FIG. 5 is a schematic view of a pedal assembly according to a second embodiment of the present disclosure; and

FIG. 6 is a flowchart representation of a method of controlling a vehicle according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

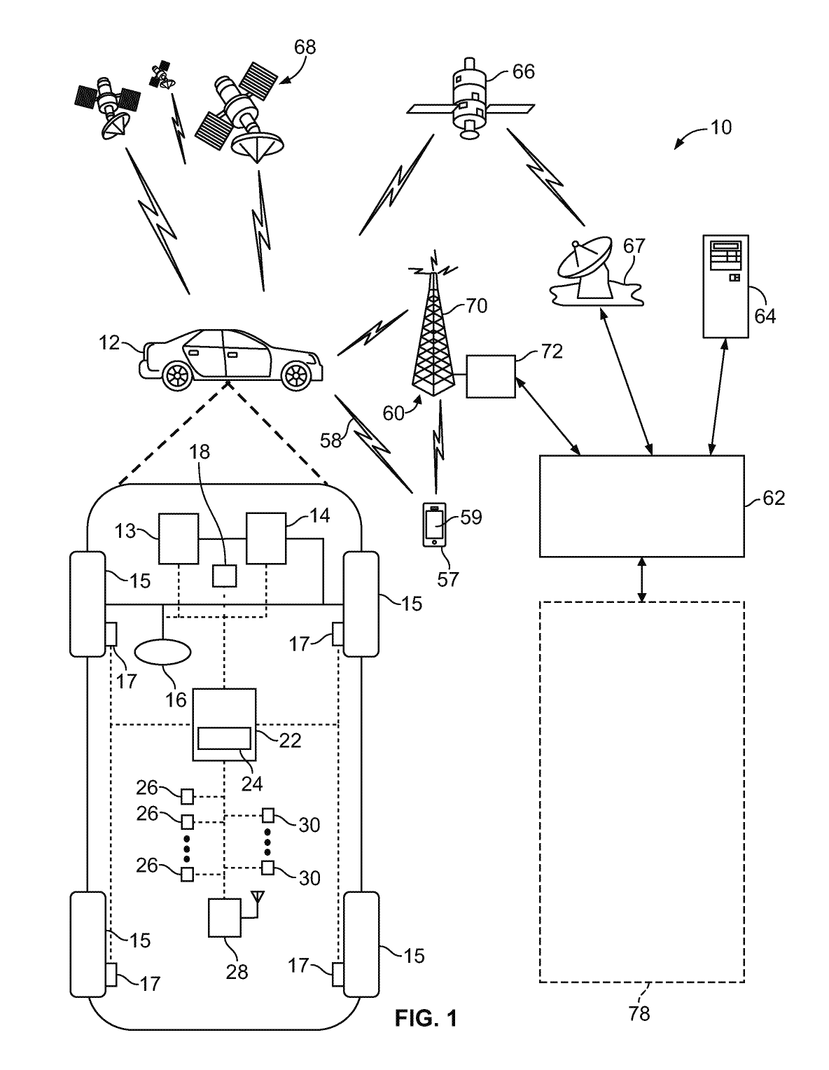

FIG. 1 schematically illustrates an operating environment that comprises a mobile vehicle communication and control system 10 for a motor vehicle 12. The communication and control system 10 for the vehicle 12 generally includes one or more wireless carrier systems 60, a land communications network 62, a computer 64, a mobile device 57 such as a smart phone, and a remote access center 78.

The vehicle 12, shown schematically in FIG. 1, is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. The vehicle 12 includes a propulsion system 13, which may in various embodiments include an internal combustion engine, an electric machine such as a traction motor, and/or a fuel cell propulsion system.

The vehicle 12 also includes a transmission 14 configured to transmit power from the propulsion system 13 to a plurality of vehicle wheels 15 according to selectable speed ratios. According to various embodiments, the transmission 14 may include a step-ratio automatic transmission, a continuously-variable transmission, or other appropriate transmission.

The vehicle 12 additionally includes wheel brakes 17 configured to provide braking torque to the vehicle wheels 15. The wheel brakes 17 may, in various embodiments, include friction brakes, a regenerative braking system such as an electric machine, and/or other appropriate braking systems.

The vehicle 12 additionally includes a steering system 16. While depicted as including a steering wheel for illustrative purposes, in some embodiments contemplated within the scope of the present disclosure, the steering system 16 may not include a steering wheel.

The vehicle 12 additionally includes at least one control pedal assembly 18. In an exemplary embodiment, the at least one control pedal assembly 18 includes a first pedal, which may be referred to as an accelerator pedal, for controlling the propulsion system 13 and a second pedal, which may be referred to as a brake pedal, for controlling the wheel brakes 17. The at least one pedal assembly 18 is provided in a pedal box. A pedal box refers to a pedal assembly comprising one or more pedal assembly 18, a pivot arm or pivot pin to which the pedal assembly 18 is pivotably coupled, and a mounting assembly or housing supporting the pivot pin and the pedal 18. The mounting assembly or housing may be coupled to a vehicle floor, interior panel, or other structural point positioned proximate a driver seat for access by an operator of the vehicle 12.

The vehicle 12 includes a wireless communications system 28 configured to wirelessly communicate with other vehicles (“V2V”) and/or infrastructure (“V2I”). In an exemplary embodiment, the wireless communication system 28 is configured to communicate via a dedicated short-range communications (DSRC) channel. DSRC channels refer to one-way or two-way short-range to medium-range wireless communication channels specifically designed for automotive use and a corresponding set of protocols and standards. However, wireless communications systems configured to communicate via additional or alternate wireless communications standards, such as IEEE 802.11 and cellular data communication, are also considered within the scope of the present disclosure.

The propulsion system 13, transmission 14, steering system 16, wheel brakes 17, and pedal assembly 18 are in communication with or under the control of at least one controller 22. While depicted as a single unit for illustrative purposes, the controller 22 may additionally include one or more other controllers, collectively referred to as a “controller.” The controller 22 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

The controller 22 includes an automated driving system (ADS) 24 for automatically controlling various actuators in the vehicle. In an exemplary embodiment, the ADS 24 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. In an exemplary embodiment, the ADS 24 is configured to control the propulsion system 13, transmission 14, steering system 16, and wheel brakes 17 to control vehicle acceleration, steering, and braking, respectively, without human intervention via a plurality of actuators 30 in response to inputs from a plurality of sensors 26, which may include GPS, RADAR, LIDAR, optical cameras, thermal cameras, ultrasonic sensors, and/or additional sensors as appropriate.

FIG. 1 illustrates several networked devices that can communicate with the wireless communication system 28 of the vehicle 12. One of the networked devices that can communicate with the vehicle 12 via the wireless communication system 28 is the mobile device 57. The mobile device 57 can include computer processing capability, a transceiver capable of communicating using a short-range wireless protocol, and a visual smart phone display 59. The computer processing capability includes a microprocessor in the form of a programmable device that includes one or more instructions stored in an internal memory structure and applied to receive binary input to create binary output. In some embodiments, the mobile device 57 includes a GPS module capable of receiving GPS satellite signals and generating GPS coordinates based on those signals. In other embodiments, the mobile device 57 includes cellular communications functionality such that the mobile device 57 carries out voice and/or data communications over the wireless carrier system 60 using one or more cellular communications protocols, as are discussed herein. The visual smart phone display 59 may also include a touch-screen graphical user interface.

The wireless carrier system 60 is preferably a cellular telephone system that includes a plurality of cell towers 70 (only one shown), one or more mobile switching centers (MSCs) 72, as well as any other networking components required to connect the wireless carrier system 60 with the land communications network 62. Each cell tower 70 includes sending and receiving antennas and a base station, with the base stations from different cell towers being connected to the MSC 72 either directly or via intermediary equipment such as a base station controller. The wireless carrier system 60 can implement any suitable communications technology, including for example, analog technologies such as AMPS, or digital technologies such as CDMA (e.g., CDMA2000) or GSM/GPRS. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from using the wireless carrier system 60, a second wireless carrier system in the form of satellite communication can be used to provide uni-directional or bi-directional communication with the vehicle 12. This can be done using one or more communication satellites 66 and an uplink transmitting station 67. Uni-directional communication can include, for example, satellite radio services, wherein programming content (news, music, etc.) is received by the transmitting station 67, packaged for upload, and then sent to the satellite 66, which broadcasts the programming to subscribers. Bi-directional communication can include, for example, satellite telephony services using the satellite 66 to relay telephone communications between the vehicle 12 and the station 67. The satellite telephony can be utilized either in addition to or in lieu of the wireless carrier system 60.

The land network 62 may be a conventional land-based telecommunications network connected to one or more landline telephones and connects the wireless carrier system 60 to the remote access center 78. For example, the land network 62 may include a public switched telephone network (PSTN) such as that used to provide hardwired telephony, packet-switched data communications, and the Internet infrastructure. One or more segments of the land network 62 could be implemented through the use of a standard wired network, a fiber or other optical network, a cable network, power lines, other wireless networks such as wireless local area networks (WLANs), or networks providing broadband wireless access (BWA), or any combination thereof. Furthermore, the remote access center 78 need not be connected via land network 62, but could include wireless telephony equipment so that it can communicate directly with a wireless network, such as the wireless carrier system 60.

While shown in FIG. 1 as a single device, the computer 64 may include a number of computers accessible via a private or public network such as the Internet. Each computer 64 can be used for one or more purposes. In an exemplary embodiment, the computer 64 may be configured as a web server accessible by the vehicle 12 via the wireless communication system 28 and the wireless carrier 60. Other computers 64 can include, for example: a service center computer where diagnostic information and other vehicle data can be uploaded from the vehicle via the wireless communication system 28 or a third party repository to or from which vehicle data or other information is provided, whether by communicating with the vehicle 12, the remote access center 78, the mobile device 57, or some combination of these. The computer 64 can maintain a searchable database and database management system that permits entry, removal, and modification of data as well as the receipt of requests to locate data within the database. The computer 64 can also be used for providing Internet connectivity such as DNS services or as a network address server that uses DHCP or other suitable protocol to assign an IP address to the vehicle 12. The computer 64 may be in communication with at least one supplemental vehicle in addition to the vehicle 12. The vehicle 12 and any supplemental vehicles may be collectively referred to as a fleet.

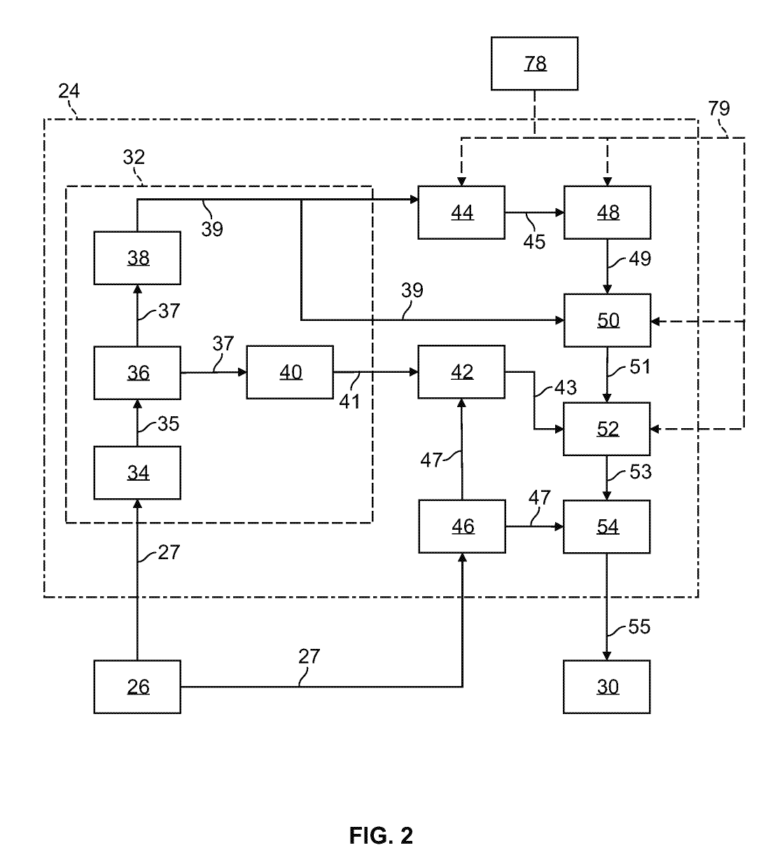

As shown in FIG. 2, the ADS 24 includes multiple distinct control systems, including at least a perception system 32 for determining the presence, location, classification, and path of detected features or objects in the vicinity of the vehicle. The perception system 32 is configured to receive inputs from a variety of sensors, such as the sensors 26 illustrated in FIG. 1, and synthesize and process the sensor inputs to generate parameters used as inputs for other control algorithms of the ADS 24.

The perception system 32 includes a sensor fusion and preprocessing module 34 that processes and synthesizes sensor data 27 from the variety of sensors 26. The sensor fusion and preprocessing module 34 performs calibration of the sensor data 27, including, but not limited to, LIDAR to LIDAR calibration, camera to LIDAR calibration, LIDAR to chassis calibration, and LIDAR beam intensity calibration. The sensor fusion and preprocessing module 34 outputs preprocessed sensor output 35.

A classification and segmentation module 36 receives the preprocessed sensor output 35 and performs object classification, image classification, traffic light classification, object segmentation, ground segmentation, and object tracking processes. Object classification includes, but is not limited to, identifying and classifying objects in the surrounding environment including identification and classification of traffic signals and signs, RADAR fusion and tracking to account for the sensor's placement and field of view (FOV), and false positive rejection via LIDAR fusion to eliminate the many false positives that exist in an urban environment, such as, for example, manhole covers, bridges, overhead trees or light poles, and other obstacles with a high RADAR cross section but which do not affect the ability of the vehicle to travel along its path. Additional object classification and tracking processes performed by the classification and segmentation model 36 include, but are not limited to, freespace detection and high level tracking that fuses data from RADAR tracks, LIDAR segmentation, LIDAR classification, image classification, object shape fit models, semantic information, motion prediction, raster maps, static obstacle maps, and other sources to produce high quality object tracks. The classification and segmentation module 36 additionally performs traffic control device classification and traffic control device fusion with lane association and traffic control device behavior models. The classification and segmentation module 36 generates an object classification and segmentation output 37 that includes object identification information.

A localization and mapping module 40 uses the object classification and segmentation output 37 to calculate parameters including, but not limited to, estimates of the position and orientation of vehicle 12 in both typical and challenging driving scenarios. These challenging driving scenarios include, but are not limited to, dynamic environments with many cars (e.g., dense traffic), environments with large scale obstructions (e.g., roadwork or construction sites), hills, multi-lane roads, single lane roads, a variety of road markings and buildings or lack thereof (e.g., residential vs. business districts), and bridges and overpasses (both above and below a current road segment of the vehicle).

The localization and mapping module 40 also incorporates new data collected as a result of expanded map areas obtained via onboard mapping functions performed by the vehicle 12 during operation and mapping data “pushed” to the vehicle 12 via the wireless communication system 28. The localization and mapping module 40 updates previous map data with the new information (e.g., new lane markings, new building structures, addition or removal of constructions zones, etc.) while leaving unaffected map regions unmodified. Examples of map data that may be generated or updated include, but are not limited to, yield line categorization, lane boundary generation, lane connection, classification of minor and major roads, classification of left and right turns, and intersection lane creation. The localization and mapping module 40 generates a localization and mapping output 41 that includes the position and orientation of the vehicle 12 with respect to detected obstacles and road features.

A vehicle odometry module 46 receives data 27 from the vehicle sensors 26 and generates a vehicle odometry output 47 which includes, for example, vehicle heading and velocity information. An absolute positioning module 42 receives the localization and mapping output 41 and the vehicle odometry information 47 and generates a vehicle location output 43 that is used in separate calculations as discussed below.

An object prediction module 38 uses the object classification and segmentation output 37 to generate parameters including, but not limited to, a location of a detected obstacle relative to the vehicle, a predicted path of the detected obstacle relative to the vehicle, and a location and orientation of traffic lanes relative to the vehicle. Data on the predicted path of objects (including pedestrians, surrounding vehicles, and other moving objects) is output as an object prediction output 39 and is used in separate calculations as discussed below.

The ADS 24 also includes an observation module 44 and an interpretation module 48. The observation module 44 generates an observation output 45 received by the interpretation module 48. The observation module 44 and the interpretation module 48 allow access by the remote access center 78. The interpretation module 48 generates an interpreted output 49 that includes additional input provided by the remote access center 78, if any.

A path planning module 50 processes and synthesizes the object prediction output 39, the interpreted output 49, and additional routing information 79 received from an online database or the remote access center 78 to determine a vehicle path to be followed to maintain the vehicle on the desired route while obeying traffic laws and avoiding any detected obstacles. The path planning module 50 employs algorithms configured to avoid any detected obstacles in the vicinity of the vehicle, maintain the vehicle in a current traffic lane, and maintain the vehicle on the desired route. The path planning module 50 outputs the vehicle path information as path planning output 51. The path planning output 51 includes a commanded vehicle path based on the vehicle route, vehicle location relative to the route, location and orientation of traffic lanes, and the presence and path of any detected obstacles.

A first control module 52 processes and synthesizes the path planning output 51 and the vehicle location output 43 to generate a first control output 53. The first control module 52 also incorporates the routing information 79 provided by the remote access center 78 in the case of a remote take-over mode of operation of the vehicle.

A vehicle control module 54 receives the first control output 53 as well as velocity and heading information 47 received from vehicle odometry 46 and generates vehicle control output 55. The vehicle control output 55 includes a set of actuator commands to achieve the commanded path from the vehicle control module 54, including, but not limited to, a steering command, a shift command, a throttle command, and a brake command.

The vehicle control output 55 is communicated to actuators 30. In an exemplary embodiment, the actuators 30 include a steering control, a shifter control, a throttle control, and a brake control. The steering control may, for example, control a steering system 16 as illustrated in FIG. 1. The shifter control may, for example, control a transmission 14 as illustrated in FIG. 1. The throttle control may, for example, control a propulsion system 13 as illustrated in FIG. 1. The brake control may, for example, control wheel brakes 17 as illustrated in FIG. 1.

In the illustrated embodiment, the vehicle 12 is a so-called dual mode vehicle, capable of being operated by a human driver or by the ADS 24. When the vehicle 12 is under the control of a human driver, control interfaces such as a steering wheel and the at least one pedal 18 should be accessible by the human driver. However, when the vehicle 12 is under the control of the ADS 24, human operation of such control interfaces may be unnecessary, undesirable, or both.

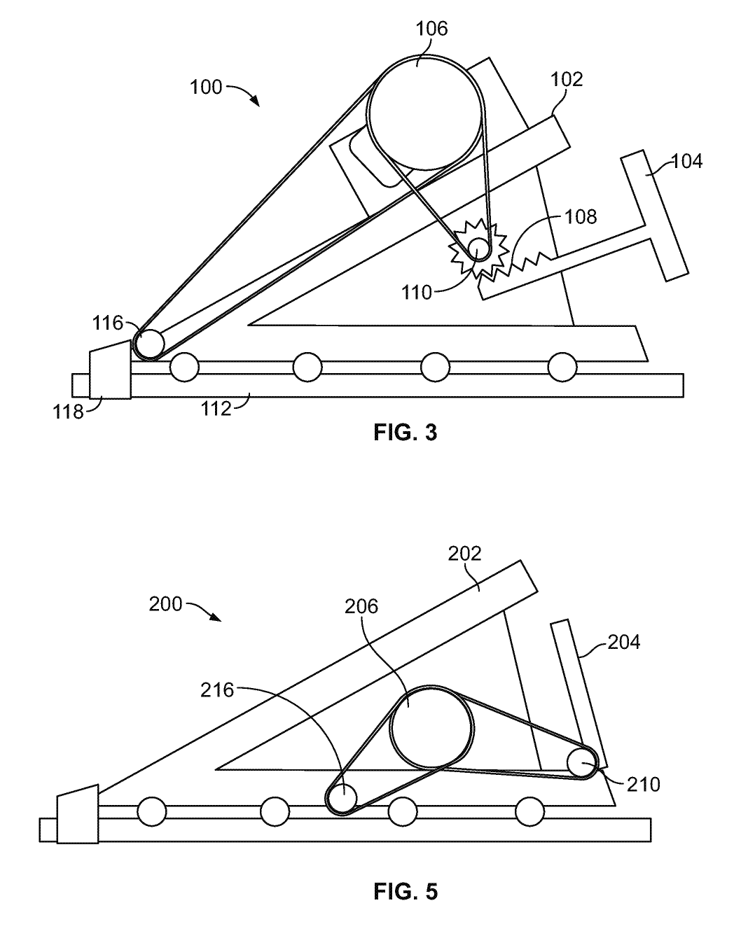

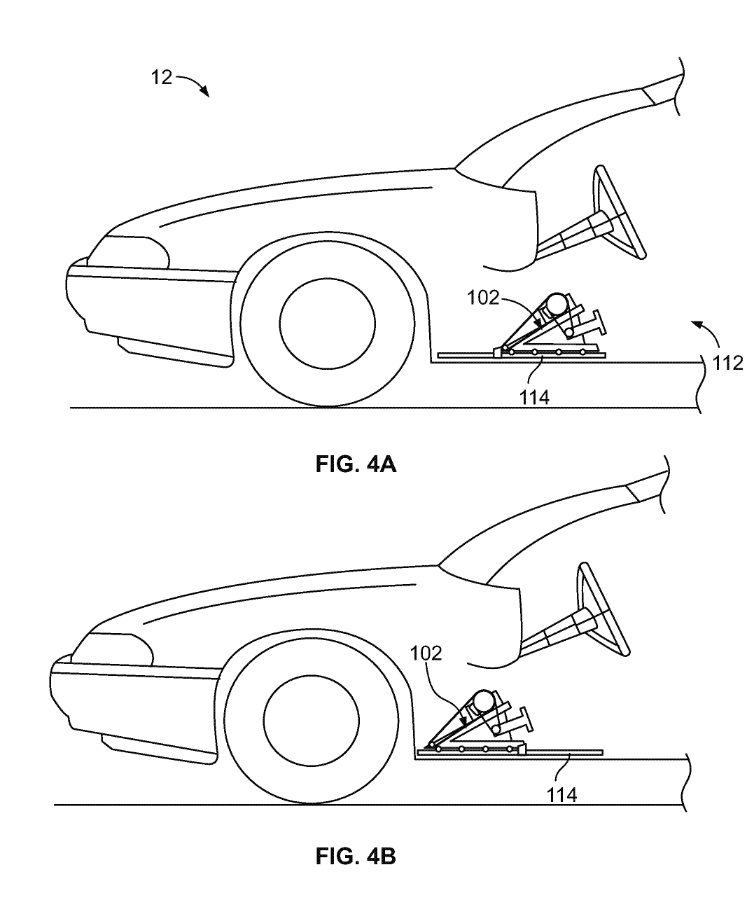

Referring now to FIGS. 3 and 4, a pedal assembly 100 according to an embodiment of the present disclosure is illustrated. The pedal assembly 100 includes a pedal housing 102. The pedal housing 102 has a pedal arm 104 configured to translate relative to the pedal housing 102 when depressed by an operator. In an exemplary embodiment, the pedal housing 102 is provided with at least one rail or track along which the pedal arm 104 may slide. In other embodiments, the pedal arm 104 may be slidably coupled to the pedal housing 102 in other configurations. While only one pedal arm 104 is illustrated in the embodiment of FIG. 3, other embodiments may include one or more additional pedal arms having similar configurations. The pedal arm 104 and any additional pedal arms may function as accelerator pedals, brake pedals or other control interfaces as appropriate. Pedal position sensors in communication with the controller 22 may detect a position of the pedal arm 104 relative to the pedal housing 102, and the controller 22 may control the wheel brakes 17 or propulsion system 13 accordingly based on a brake-by-wire or throttle-by-wire schema.

The pedal assembly 100 also includes at least one actuator 106. In various embodiments, the actuator may be physically secured to an exterior or interior portion of the pedal housing 102, or secured to a portion of the vehicle 12 remote from the pedal housing 12. The actuator 106 is in communication with or under the control of the controller 22. The actuator 106 may comprise an electric motor, an accumulator, other suitable actuator type, or any combination thereof.

The actuator 106 is selectively operable according to at least a first mode and a second mode based on commands from the controller 22. In an exemplary embodiment, the actuator 106 is provided with a transmission configured to selectively transmit torque from the actuator 106 in a first flowpath to a first gearing element 110, as will be discussed in further detail below, or in a second flowpath to a second gearing element 116, as will be discussed in further detail below.

In the first mode, which may be referred to as a force feedback mode, the actuator 106 provides a return force on the pedal arm 104. The return force resists operator application of the pedal arm 104, and also serves to return the pedal arm 104 to a default position upon operator release of the pedal arm 104. The return force F has a magnitude controllable by the controller 22. In an exemplary embodiment, the controller 22 is provided with a calibration table specifying a return force magnitude based on position of the pedal arm 104.

In the embodiment illustrated in FIG. 3, the pedal arm 104 is coupled to a shaft having a plurality of gear teeth 108. The actuator 106 is operatively coupled to a first gearing element 110, e.g. a spur gear, in meshing engagement with the gear teeth 108. The actuator 106 may be coupled to the first gearing element 110 via a chain, belt, or any other suitable connection. The actuator 106 may apply torque to the gearing element and, in turn, thereby apply the return force F to the pedal arm 104.

In the second mode, which may be referred to as a stowage mode, the actuator 106 provides a motive force to move the pedal housing 102 between a plurality of positions. The pedal housing 102 is slidably coupled to a rail or track 112, which is in turn coupled to an interior portion of an occupant cabin 114, as illustrated in FIGS. 4A and 4B. In the illustrated embodiment the rail or track 112 is disposed on a floor of the cabin 114; however, in other embodiments the rail or track may be coupled to other portions of the cabin as appropriate. In an exemplary embodiment, a plurality of roller elements may be provided between the pedal housing 102 and the rail or track 112 to facilitate relative translation therebetween.

The actuator 106 is operatively coupled to a second gearing element 116 which is configured to effect translation between the housing 102 and the rail or track 112. The actuator 106 may be coupled to the second gearing element 116 via a chain, belt, or any other suitable connection. In an exemplary embodiment, the rail or track 112 is provided with a plurality of gear teeth, and the second gearing element 116 comprises a spur gear in meshing engagement with the gear teeth. However, in other embodiments the second gearing element 116 may be coupled to a chain drive, belt drive, or other drive system for translating the housing 102 relative to the rail or track 112. The actuator 106 may control the second gearing element 116 to rotate in a first direction to translate the housing 102 from a first position, illustrated in FIG. 4A, to a second position, illustrated in FIG. 4B. Likewise, the actuator 106 may control the second gearing element 116 to rotate in a second direction to translate the housing 102 from the second position to the first position. The first position may be referred to as a deployed position, and the second position may be referred to as a stowed position.

A locking member 118 is provided in the cabin 114 proximate the rail or track 112. The locking member 118 may comprise a cam, pawl, or other similar feature configured to selectively retain the pedal housing 102 in the first position or in the second position. The locking member 118 may be controlled by an actuator, e.g. a solenoid, in communication with or under the control of the controller 22.

Referring now to FIG. 5, a pedal assembly 200 according to a second embodiment of the present disclosure is illustrated. The pedal assembly 200 includes a pedal housing 202 with a pedal arm 204.

The pedal assembly 200 is provided with an actuator 206, first gearing element 210, and second gearing element 216 arranged generally similarly to the actuator 106, first gearing element 110, and second gearing element 116 discussed above in conjunction with FIG. 3. The pedal arm 204 is fixedly coupled to the first gearing element 210 for co-pivoting motion, such that operator application of the pedal arm 204 causes pivoting motion of the first gearing element 210.

The actuator 206 is selectively operable according to a force feedback mode and a stowage mode, generally similarly as discussed above with respect to the actuator 106 of FIG. 3.

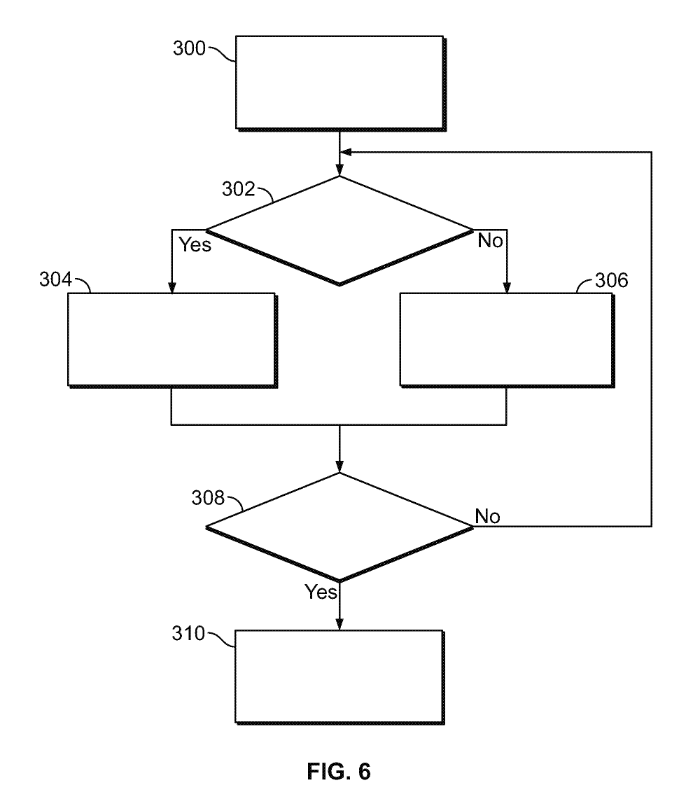

Referring now to FIG. 6, a method of controlling an automotive vehicle is illustrated in flowchart form.

A vehicle drive cycle begins, as illustrated at block 300.

A determination is made of whether the vehicle is under control of the ADS 24, as illustrated at operation 302. In an exemplary embodiment, this determination is made by the controller 22.

If the determination of operation 302 is positive, i.e. the vehicle is under the control of the ADS 24, then the pedal housing is controlled to a stowed position, as illustrated at block 304. This may be performed, for example, by the mechanisms and methods discussed above with respect to FIGS. 3 through 5.

If the determination of operation 302 is negative, i.e. the vehicle is not under the control of the ADS 24, then the pedal housing is controlled to a deployed position and the actuator is controlled in the force feedback mode, as illustrated at block 306. This may be performed, for example, by the mechanisms and methods discussed above with respect to FIGS. 3 through 5.

Subsequent either block 304 or block 306, a determination is made of whether the drive cycle has terminated, as illustrated at block 308. In an exemplary embodiment, this determination is made by the controller 22.

If the determination of operation 308 is negative, i.e. the drive cycle has not ended, then control returns to operation 302. The algorithm thus monitors ADS control of the vehicle and controls the pedal assembly accordingly unless and until the current drive cycle terminates.

If the determination of operation 308 is positive, i.e. the drive cycle has ended, then the pedal assembly is controlled to a default position, as illustrated at block 310. In an exemplary embodiment, the default position corresponds to the deployed position. However, in other embodiments the default position may correspond to the stowed position. The algorithm then terminates.

As may be seen the present disclosure provides a system and method for providing control interfaces to a vehicle operator when useful, and moving such control interfaces out of the operator's way when unnecessarily, thereby avoiding unintentional control inputs and increasing occupant comfort. Moreover, systems and methods according to the present disclosure may provide these benefits in a relatively compact package while also providing force-feedback to

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An automotive vehicle comprising:
a body having a passenger compartment;
a movable pedal housing disposed within the passenger compartment, the movable pedal housing being movable between a first position with respect to the passenger compartment and a second position with respect to the passenger compartment;
at least one pedal operably coupled to the housing and actuatable by an occupant;
an actuator operably coupled to the pedal and to the housing, the actuator being configured to apply a resistive force to the pedal to resist motion of the pedal, the resistive force having a controllable magnitude, the actuator being configured to selectively move the housing between the first position and the second position; and
at least one controller in communication with the actuator, the at least one controller being configured to, in response to satisfaction of a first operating condition, control the actuator to move the pedal housing to the first position, and, in response to satisfaction of a second operating condition, control the actuator to move the pedal housing to the second position.

2. The automotive vehicle of claim 1, further comprising a shaft coupled to the pedal and a gearing element operably coupled to the actuator, wherein the shaft is provided with a plurality of gear teeth in meshing engagement with the gearing element such that translation of the shaft drives the gearing element in rotation.

3. The automotive vehicle of claim 1, further comprising a rail coupled to an interior portion of the passenger compartment, the pedal housing being slidably coupled to the rail.

4. The automotive vehicle of claim 3, further comprising a locking member disposed at the interior portion of the passenger compartment, the locking member being selectively engageable with the pedal housing to secure the pedal housing in a fixed position relative to the rail.

5. The automotive vehicle of claim 1, wherein the first operating condition comprises an automated driving system controlling vehicle driving behavior, and wherein the second operating condition comprises the automated driving system not controlling vehicle driving behavior.

6. A pedal assembly for a vehicle, comprising:
a track;
a pedal housing slidably coupled to the track;
at least one pedal operably coupled to the housing and actuatable by an occupant;
an actuator operably coupled to the pedal housing and configured to selectively move the housing between a stowed position with respect to the track and a deployed position with respect to the track, the actuator being configured to actuate the pedal housing to the deployed position in response to a deploy command from a controller and to actuate the pedal housing to the stowed position in response to a stow command from the controller.

7. The pedal assembly of claim 6, wherein the actuator is operably coupled to the pedal and configured to apply a resistive force to the pedal to resist motion of the pedal, the resistive force having a controllable magnitude.

8. The pedal assembly of claim 7, further comprising a shaft coupled to the pedal and a gearing element operably coupled to the actuator, wherein the shaft is provided with a plurality of gear teeth in meshing engagement with the gearing element such that translation of the shaft drives the gearing element in rotation.

9. The pedal assembly of claim 6, wherein the controller is configured to generate the deploy command in response to satisfaction of a first operating condition and to generate the stow command in response to satisfaction of a second operating condition.

10. The pedal assembly of claim 9, wherein the second operating condition comprises an automated driving system controlling vehicle driving behavior, and wherein the first operating condition comprises the automated driving system not controlling vehicle driving behavior.

15. A method of controlling an automotive vehicle comprising:
providing a vehicle with a first actuator configured to control vehicle acceleration or braking, a controller configured to selectively control the actuator in an autonomous mode according to an automated driving system, a pedal assembly having a housing and at least one pedal operably coupled to the pedal housing, and a second actuator coupled to the pedal housing and operably coupled to the pedal housing and to the pedal;
in response to the controller controlling the first actuator in the autonomous mode, automatically controlling the second actuator, via the controller, to actuate the pedal housing to a stowed position; and
in response to the controller not controlling the first actuator in the autonomous mode, automatically controlling the second actuator, via the controller, to actuate the pedal housing to a deployed position and to apply a resistive force to the pedal to resist motion of the pedal.
